(19) United States
(12) Patent Application Publication
(10) Pub. No.: US 2017/0096577 A1
(43) Pub. Date: Apr. 6, 2017

(54) PRIMER-LESS COATED SUBSTRATES

(71) Applicant: PRC-DeSoto International. Inc., Sylmar, CA (US)

(72) Inventors: Siamanto Abrami, Glendale, CA (US); Anni Kazorian, Glendale, CA (US); Michael A. Mayo, Pittsburgh, PA (US)

(21) Appl. No.: 14/872,491

(22) Filed: Oct. 1, 2015

(51) Int. Cl. C09D 163/00; B05D 7/00; C09D 5/08

(52) U.S. Cl. CPC C09D 163/00; C09D 5/08; B05D 7/536

(57) ABSTRACT

A substrate coated at least in part with an epoxy coating composition, wherein the substrate is not coated with an organic coating prior to the application of the epoxy coating composition is disclosed, as are methods for making such a substrate.

### FIELD OF THE INVENTION

The present invention is directed to a substrate at least partially coated with an epoxy coating composition comprising a corrosion inhibitor, a non-aromatic epoxy resin and an amine, wherein the substrate is not coated prior to application of the epoxy coating. Methods for coating a substrate are also within the scope of the invention.

### BACKGROUND OF THE INVENTION

Primers and basecoat layers may be used together to coat a substrate. The primer typically improves adhesion of the basecoat layer to the substrate. The primer may also provide protection to the substrate, such as protection against corrosion. Basecoats typically provide decorative as well as protective value to the coated substrate. Other layers may be applied on top of the basecoat, such as a clearcoat. Incorporation of some or all of the primer properties into the basecoat may be desired to eliminate the need for application and cure of two separate coating layers.

### SUMMARY OF THE INVENTION

The present invention is directed to a substrate at least partially coated with an epoxy coating composition comprising a corrosion inhibitor, a non-aromatic epoxy resin, and an amine curing agent, wherein the substrate is not coated prior to application of the epoxy coating.

The present invention is also directed to a method for preparing a coated substrate comprising applying the above coating directly to at least a portion of the substrate and at least partially curing the coating composition.

### DETAILED DESCRIPTION OF THE INVENTION

The present invention is directed to a substrate at least partially coated with an epoxy coating composition comprising a corrosion inhibitor, a non-aromatic epoxy resin and an amine. This coating composition is sometimes referred to herein as the “epoxy coating composition”, “epoxy coating” or “epoxy layer”. The epoxy coating is typically a multi-component coating, since many epoxy resins and amine resins will react upon contact.

According to the present invention, the substrate is not coated with an organic coating prior to application of the epoxy coating; the substrate is therefore sometimes referred to herein as the “uncoated substrate”. An uncoated substrate is one that does not have an organic coating applied thereto. Use of a traditional organic coating prior to application of the epoxy coating, such as an organic primer coating, is therefore excluded according to the present invention. The term “organic coating” refers to a coating in which the binder or film forming resin(s) used in the coating are organic; it will be understood that inorganic material may be used in organic coatings but such inorganic material does not typically participate in film formation. It is an unexpected advantage that the epoxy layer used according to the present invention can be used without an organic primer layer and still give acceptable performance.

The substrates coated according to the present invention can be bare substrates; that is, not treated and/or cleaned in any way. Suitable substrates, however, can also be pretreated in any manner known in the art prior to application of the epoxy coating. For example, the bare surface of the substrate may be treated with a pretreatment composition and/or a conversion coating. It will be understood that these compositions or coatings are inorganic, and thus distinguished from typical organic coatings used in primer layers. A “bare surface” may also have other impurities or atmospheric contaminants on the surface, such as natural metal oxide formation (e.g. aluminum oxide), condensation, smut, etc.

The uncoated substrate can be prepared by any procedure known in the art, including, but not limited to, abrading, rinsing, degreasing, cleaning, desmutting, deoxidizing, and the like. Following this preparation, the substrate can be subjected to a pretreatment or conversion coating step. As used herein, the terms “pretreatment” and “conversion coating” each refer to any pretreatment regimen or composition that prepares the surface for coating. The terms “pretreatment” and “conversion coating” are often used interchangeably in the art as both refer to surface treatment prior to deposition of an organic coating. More than one surface treatment can be performed. Typically, if two surface treatments are performed, the first is referred to as “pretreatment” and the second as “conversion coating”. Treating a substrate with a pretreatment and/or a conversion coating does not deposit or apply an organic coating on the substrate that one of ordinary skill in the art would equate with a “primer” or “basecoat.” Instead, these procedures clean and/or otherwise prepare the surface of the substrate for subsequent application of a coating. Moreover, if such treatments leave a residue or film on the surface, such residue or film would typically be less than 2 microns in thickness. Accordingly, when describing the substrate of the present invention as “not coated prior to application of the epoxy coating”, this contemplates that the uncoated substrate may have a conversion coating and/or a pretreatment residue prior to application of the epoxy coating.

The conversion coating may include any suitable conversion coating (e.g., a sol-gel, chrome, zirconium, phosphate, cerium, and/or lithium based conversion coating) used in the art, which are widely commercially available. For example, a suitable sol-gel composition for conversion coating is DESOGEL EAP-9 (available from PRC-DeSoto International, Inc.). The sol-gel composition may further include an organic acid catalyst and a zirconium stabilizer. Those of ordinary skill in the art would readily understand how to prepare such a sol-gel.

The epoxy coating composition used herein includes a corrosion inhibitor, a non-aromatic epoxy resin and an amine. Any corrosion inhibitor can be used according to the present invention. As used herein, the term “corrosion inhibitor” refers to materials, compounds and the like, such as particles, that, when included in a coating composition deposited upon a substrate, act to provide a coating that resists or, in some cases, even prevents, the alteration or degradation of the substrate, such as by a chemical or electrochemical oxidizing process, including rust in iron containing substrates and degradative oxides in aluminum substrates.

The corrosion inhibitors used in the present epoxy coating may comprise an oxide of zinc, cerium, yttrium, manganese, magnesium, molybdenum, lithium, aluminum, magnesium, tin, or calcium, such as an oxide of magnesium, zinc, cerium, calcium or combinations thereof. The particles may also comprise one or more of an oxide of boron, phosphorous, silicon, zirconium, iron, or titanium in addition to or instead of the other listed oxide particles. In a particular epoxy coating, the particles comprise silicon dioxide (“silica”). Other examples of corrosion inhibitors include, but are not limited to, iron phosphate, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX. AC3 and/or SHIELDEX. C303. Suitable amorphous silica is available from W. R. Grace & Co. as SYLOID. Suitable zinc hydroxyl phosphate is commercially available from Elementis Specialties, Inc. as NALZIN 2.

The epoxy coatings used herein may also comprise one or more organic corrosion inhibitors. Examples of such inhibitors include but are not limited to sulfur and/or nitrogen containing heterocyclic compounds, examples of which include azoles, thiophene, hydrazine and derivatives, and pyrrole and derivatives. Such organic inhibitors are described in U.S. Publication No. 2013/0065985, Paragraph No. 52, which is hereby incorporated by reference. When used, organic corrosion inhibitors may be present in the coating compositions in an amount ranging from 0.1 to 20 weight %, such as 0.5 to 10 weight %, with weight percent being based on the total solids weight of the blended composition.

Any corrosion inhibitor, such as MgO, of any size, such as any average particle size, can be used in the epoxy coating according to the present invention. The corrosion inhibitor may be, for example, micron sized, such as 0.5 to 50 microns or 1 to 15 microns, with size based on average particle size. The corrosion inhibitor may be, for example, nano sized, such as 10 to 499 nanometers, or 10 to 100 nanometers, with size based on average particle size. It will be appreciated that these particle sizes refer to the particle size of the corrosion inhibitor at the time of incorporation into the coating. Various coating preparation methods may result in the corrosion inhibitors agglomerating, which could increase average particle size, or shearing or other action that can reduce average particle size. Corrosion inhibitors are commercially available from a number of sources.

For example, certain epoxy coating compositions used in the present invention comprise ultrafine corrosion inhibitors. As used herein, the term “ultrafine” refers to particles that have a B.E.T. specific surface area of at least 10 square meters per gram, such as 30 to 500 square meters per gram, or, in some cases, 80 to 250 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

The epoxy coating compositions used in the present invention may comprise a corrosion inhibitor, such as MgO particles, having a calculated equivalent spherical diameter of no more than 200 nanometers, such as no more than 100 nanometers, or, in certain embodiments, 5 to 50 nanometers. The calculated equivalent spherical diameter values given above are determined from the B.E.T. specific surface area according to the following equation: Diameter (nanometers)=6000/[BET (m.sup.2/g)*.rho.(grams/cm.sup.3)].

Certain epoxy coating compositions of the present invention may comprise corrosion inhibitors, such as MgO particles, having an average primary particle size of no more than 100 nanometers, such as no more than 50 nanometers, or, in certain embodiments, no more than 25 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

The corrosion inhibitor may have an affinity for the medium of the composition sufficient to keep the corrosion inhibitor suspended therein. For example, if the corrosion inhibitor is in particulate form, the affinity of the particles for the medium may be greater than the affinity of the particles for each other, thereby reducing or eliminating agglomeration of the particles within the medium.

The shape (or morphology) of particulate corrosion inhibitor, such as MgO particles, can vary. For example, generally spherical morphologies can be used, as well as particles that are cubic, platy, polyhedric, or acicular (elongated or fibrous). The particles may be covered completely in a polymeric gel, not covered at all in a polymeric gel, or covered partially with a polymeric gel. “Covered partially with a polymeric gel” means that at least some portion of the particle has a polymeric gel deposited thereon, which, for example, may be covalently bonded to the particle or merely associated with the particle.

The amount of corrosion inhibitor, such as MgO, used in the present epoxy coatings can vary depending on the needs of the user. For example, the present coatings can comprise 1 to 75 weight % particles, such as 5 to 50 or 10 to 50, with weight % based on the total solids, including pigments, of the blended coating. By “blended coating” is meant the coating that is applied to a substrate; that is, the coating that results from two or more components being mixed together, such as an epoxy component and an amine component.

The corrosion inhibitors used in the epoxy coating may specifically exclude praseodymium. Still other coatings may specifically exclude all rare earth elements. By rare earth is meant a collection of seventeen chemical elements in the periodic table, specifically the fifteen lanthanoids (the fifteen elements with atomic numbers 57 through 71, from lanthanum to lutetium) plus scandium and yttrium. The epoxy coatings may exclude chromium or chromium-containing compounds. As used herein, the term “chromium-containing compound” refers to materials that include hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate. When a coating composition and/or a coating comprising the same is substantially free, essentially free, or completely free of chromium, this includes chromium in any form, such as, but not limited to, the hexavalent chromium-containing compounds listed above.

Thus, the present coating compositions and/or coatings comprising the same may be substantially free, may be essentially free, and/or may be completely free of one or more of any of the elements or compounds listed in the preceding paragraph. A coating composition and/or coating comprising the same that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the composition; in the case of chromium, this may further include that the element or compounds thereof are not present in the coating compositions and/or coatings comprising the same in such a level that it causes a burden on the environment. The term “substantially free” means that the coating compositions and/or coatings comprising the same contain less than 10 ppm of any or all of the elements or compounds listed in the preceding paragraph. The term “essentially free” means that the coating compositions and/or coatings comprising the same contain less than 1 ppm of any or all of the elements or compounds listed in the preceding paragraph. The term “completely free” means that the coating compositions and/or coatings comprising the same contain less than 1 ppb of any or all of the elements or compounds listed in the preceding paragraph.

The epoxy coating compositions may also comprise an amino acid in addition to any of the other components recited herein. When present, and when a multi component coating formulation is used, the amino acid may be in any component, such as the first component, the second component or both Amino acids will be understood by those skilled in the art as compounds having both acid and amine functionality, with side chains specific to each amino acid. The amino acid may be monomeric or oligomeric, including a dimer. When an oligomeric amino acid is used, the molecular weight, as determined by GPC, of the oligomer may be less than 1000.

While any of the amino acids can be used according to the present invention, particularly suitable are histidine, arginine, lysine, cysteine, cystine, tryphtophan, methionine, phenylalanine and tyrosine. It will be further understood that amino acids can be either L- or D-enantiomers, which are mirror images of each other, and that the L-configurations are typically found in proteins and nature and as such are widely commercially available. The term “amino acids” as used herein therefore refers to both the D- and L-configurations; in some epoxy coatings, only the L- or only the D-configuration may be included. Amino acids can be purchased, for example, from Sigma Aldrich, Thermo Fisher Scientific, Hawkins Pharmaceutical, or Ajinomato. Certain embodiments of the present invention specifically exclude the amino acids glycine, arginine, proline, cysteine and/or methionine.

The amino acid can be present in any amount that improves the corrosion resistance of the coating. For example, the amino acids may be present in an amount of 0.1 to 20 weight %, such as 2 to 4 weight %, with weight percent based on resin solids in the blended coating. The amount of amino acid and the amount of corrosion inhibitor may be selected together to give the optimum corrosion resistance to a coating.

The epoxy coating composition used according to the present invention also comprises a non-aromatic epoxy resin. As used herein, the term “non-aromatic epoxy resin” refers to compounds, oligomers, prepolymers or polymers that include a reactive epoxide group and do not include an aromatic ring. The non-aromatic epoxy resin may include any suitable epoxy resin that does not include an aromatic ring. The non-aromatic epoxy resin may include an alkyl group, an alkylene group, an alkoxy group, an alkenyl group, an alkenylene group, an alkynyl group, a cycloalkyl group, a cycloalkylene group, a heterocycloalkyl group, a heterocycloalkylene group, a cycloalkenyl group (e.g., a cyclic group that has a double bond in a ring thereof and is not aromatic), a cycloalkenylene group, a heterocycloalkenyl group, a heterocycloalkenylene group, and/or a non-aromatic condensed polycyclic group, but the present disclosure is not limited thereto. The non-aromatic epoxy resin may therefore include any suitable aliphatic epoxy resin, cycloaliphatic epoxy resin or mixture thereof. The non-aromatic epoxy resin may have one or more, such as two or more reactive epoxy groups. By “reactive epoxy groups” is meant epoxy groups that can undergo reaction with another compound, such as an amine. The epoxide group of the non-aromatic resin may be bonded to another functional group via a single bond or a plurality of bonds. For example, the oxygen of the epoxide group may be bonded to two separate and adjacent carbon atoms of a cycloaliphatic ring, for example, when the non-aromatic epoxy resin includes a cycloaliphatic epoxy resin. The non-aromatic epoxy resin may have a structure according to the formula:

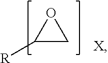

in which X is 1 to 10, and R is any suitable linear or cyclic structure having saturated or unsaturated bonds and including 1 to 200 atoms including any suitable combination of carbon, hydrogen, oxygen, sulfur, silicon, nitrogen, and/or phosphorus atoms.

Examples of suitable non-aromatic epoxy resins include acrylic polymers or oligomers including glycidyl methacrylate, aliphatic epoxy resins prepared from hydrogenated Bisphenol-A (e.g., EPONEX Resin 1510, available from Momentive, Columbus, Ohio), aliphatic monoglycidyl ether (e.g., HELOXY Modifier 8, HELOXY Modifier 61, HELOXY Modifier 62, HELOXY Modifier 65, and/or HELOXY Modifier 116, each of which is available from Momentive, Columbus, Ohio), a reaction product of reactants including epichlorohydrin and a C₁₂-C₁₄ alcohol (e.g., Dow D.E.R. 721, available from Dow Chemical Company, Midland, Mich.), a reaction product of reactants including epichlorohydrin and 2-ethylhexyl alcohol (e.g., Dow D.E.R. 728, available from Dow Chemical Company, Midland, Mich.), a cycloaliphatic epoxy resin (e.g., Dow D.E.R. 3391, available from Dow Chemical Company, Midland, Mich.), an aliphatic liquid epoxy resin (e.g., Dow D.E.R. 3912, available from Dow Chemical Company, Midland, Mich.), a reaction product of reactants including epichlorohydrin and cyclohexane-dimethanol (e.g., Dow D.E.R. 737, available from Dow Chemical Company, Midland, Mich.), a reaction product of reactants including epichlorohydrin and neopentyl glycol (e.g., Dow D.E.R. 738, available from Dow Chemical Company, Midland, Mich.), a reaction product of reactants including epichlorohydrin and trimethylolpropane (e.g., Dow D.E.R. 741, available from Dow Chemical Company, Midland, Mich.), triglycidyl ether of trimethylolpropane (e.g., HELOXY Modifier 48, available from Momentive, Columbus, Ohio), diglycidyl ether of 1,4 butanediol (e.g., HELOXY Modifier 67, available from Momentive, Columbus, Ohio), diglycidyl ether of neopentyl glycol (e.g., HELOXY Modifier 68, available from Momentive, Columbus, Ohio), diglycidyl ether of cyclohexane dimethanol (e.g., HELOXY Modifier 107, available from Momentive, Columbus, Ohio), dimer acid diglycidyl ester (e.g., HELOXY Modifier 71, available from Momentive, Columbus, Ohio), castor oil polyglycidyl ether (e.g., HELOXY Modifier 505, available from Momentive, Columbus, Ohio), glycerol propoxylate triglycidyl ether (e.g., APGE, available from Momentive, Columbus, Ohio), a reaction product of reactants including propylene glycol and/or dipropylene glycol and epichlorohydrin (e.g., D.E.R. 732 and D.E.R. 736, available from Dow Chemical Company, Midland, Mich.), 3,4-epoxycyclohexylmethyl 3,4-epoxycyclohexane carboxylate (e.g., TTA21, available from PhibroChem, Teaneck, N.J.), and bis((3,4-epoxycyclohexyl)methyl)adipate (e.g., Syna Epoxy 28, available from Synasia Inc., Metuchen, N.J.), but the present disclosure is not limited thereto. In the above-identified examples of suitable non-aromatic epoxy resins, Dow D.E.R. 741 may function as an offset to HELOXY Modifier 48, Dow D.E.R. 737 may function as an offset to HELOXY Modifier 107, and Dow D.E.R. 738 may function as an offset to HELOXY Modifier 68).

An example of a suitable cycloaliphatic epoxy resin includes

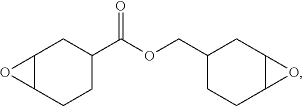 [SMILES: O=C(OCC1CCC2OC2C1)C1CCC2OC2C1]

and an example of an aliphatic epoxy resin includes

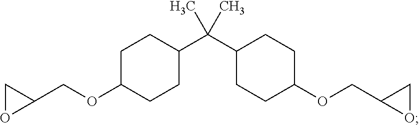 [SMILES: CC(C)(C1CCC(OCC2CO2)CC1)C1CCC(OCC2CO2)CC1]

but the present disclosure is not limited thereto. The epoxy coating composition may be free or substantially free of an epoxy silane zirconate. If epoxy silane zirconate is used as a binder or film former, it would be regarded as an inorganic binder or film former. An epoxy coating composition that is free or substantially free of an epoxy silane zirconate may be applied to at least a portion of the substrate that has been pretreated with a substance, such as a conversion coating, that includes an epoxy silane zirconate. At least a portion of the epoxy coating composition may form a chemical bond with the epoxy silane zirconate previously deposited on the uncoated surface.

In addition to the non-aromatic epoxy resin, the epoxy coating composition may optionally include an aromatic epoxy resin (e.g., a compound, oligomer, prepolymer or polymer including a reactive epoxide group and an aromatic ring) in an amount of 5 wt % or less, such as 2 wt % or less, based on the total weight of resin solids in the epoxy coating composition.

The epoxy coating composition used according to the present invention also includes an amine. One skilled in the art will appreciate that the amine serves to react with the epoxy functionality on the non-aromatic epoxy resin, thereby curing the coating composition. Any suitable amine can be used including, for example, an aliphatic amine, an adduct of an aliphatic amine, a cycloaliphatic amine, an amidoamine, a polyamide, a polyamide having one or more amine groups, or mixtures thereof. For example, the curing agent may include a mixture of amines (e.g., polyamines) and amides (e.g., polyamides, including polyamides having one or more amine groups). Examples of suitable polyamines are described in U.S. Pat. No. 4,046,729 at column 6, line 61 to column 7, line 26, and in U.S. Pat. No. 3,799,854 at column 3, lines 13 to 50, the cited portions of which are incorporated herein by reference. For example, the curing agent may include primary or secondary diamines or polyamines in which the radicals attached to the nitrogen atoms may be saturated or unsaturated, aliphatic, alicyclic, aromatic, aromatic-substituted aliphatic, aliphatic-substituted aromatic or heterocyclic. The curing agent may include a mixed amine in which radicals of the amine are different. For example, the mixed amine may include aromatic and aliphatic groups. The mixed amine may also include other non-reactive groups bonded to a carbon atom of the mixed amine. For example, the other non-reactive groups may include oxygen, sulfur, halogen or nitroso. Examples of suitable aliphatic and alicyclic diamines include: 1,2-ethylene diamine, 1,2-propylene diamine, 1,8-methane diamine, isophorone diamine, propane-2,2-cyclohexyl amine, methane-bis-(4-cyclohexyl amine), and

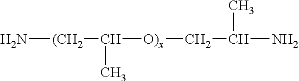

where x=1 to 10, but the present disclosure is not limited thereto. Examples of suitable commercially available amines include, but are not limited to, ANCAMINES and ANCAMIDES available from Air Products, Allentown, Pa.; RAC aromatic amine curing agents available from Royce International, Beverly Hills, Calif.; LONZACURE hardeners available from Lonza, Basel, Switzerland; JEFFAMINE polyetheramines available from Huntsman, Salt Lake City, Utah; LAROMIN hardeners available from BASF, Ludwigshafen, Germany; DYTEK Idea Intermediates available from Invista, Wichita, Kans.; and VERSAMINE polyamines available from BASF, Ludwigshafen, Germany.

The amine may also include any suitable compound including primary and/or secondary amine groups. The compound (including mixtures of compounds, which may be referred to as an organic resinous material) may have a molecular weight of 50 to 10,000 (e.g., a weight average molecular weight of 50 to 10,000 g/mol). Suitable compounds having available amine groups include polyamide resins that have terminal reactive primary amine groups and/or reactive secondary amine groups spaced along the compound (e.g., spaced along a main chain of the compound).

Polyamide resins may be produced by a condensation reaction between dimerized fatty acids, such as dimerized linoleic acid, with lower aliphatic polyamines, such as, for example, ethylene diamine or diethylene triamine, so that the final product has available amine groups. The more highly functional amines, such as, diethylene triamine, are suitable because the polyamide resins produced by a condensation reaction between a dimerized fatty acid and diethylene triamine provide resins having a lower melting point and have free amine groups spaced along the polymer. Polyamide resins are commercially available.

Another class of amines that may be used include water-dispersed products formed by reacting free carboxyl groups of polycarboxylic acid groups containing acrylic resins with an alkyleneamine or substituted alkyleneamine and neutralizing all or part of the resultant aziridine group-containing product with an acid to provide a product which is soluble or dispersible in water. The terms “dispersed” and “soluble,” and derivatives thereof, as used herein, mean dissolved in, or dispersed in water, so that the resin does not settle upon standing for a reasonable period of time and acts as a polyelectrolyte under introduced electric current.

The present epoxy coating compositions used can comprise up to 50 wt % corrosion inhibitor, such as up to 40 wt % or 20 wt %, and contain as little as 0.5 wt % or greater corrosion inhibitor, such as 1 wt % or 5 wt % or greater. The present epoxy coating compositions can comprise up to 80 wt % non-aromatic epoxy resin, such as up to 70 wt % or 60 wt %, and contain as little as 20 wt % non-aromatic epoxy resin or greater, such as 30 wt % or 40 wt % or greater. The present epoxy coating compositions can comprise up to 80 wt % amine, such as up to 70 wt % or 60 wt %, and contain as little as 10 wt % amine or greater, such as 15 wt % or 20 wt % or greater. The wt % values provided above are based on resin solids.

The coating compositions used in the present invention can also comprise any additives standard in the art of coating manufacture including colorants, plasticizers, abrasion-resistant particles, film strengthening particles, flow control agents, thixotropic agents, rheology modifiers, catalysts, antioxidants, biocides, defoamers, surfactants, wetting agents, dispersing aids, adhesion promoters, clays, hindered amine light stabilizers, UV light absorbers and stabilizers, a stabilizing agent, fillers, organic cosolvents, reactive diluents, grind vehicles, and other customary auxiliaries, or combinations thereof. The term “colorant”, as used herein is as defined in U.S. Patent Publication No. 2012/0149820, paragraphs 29 to 38, the cited portion of which is incorporated herein by reference.

As used herein, the terms “adhesion promoter” and “adhesion promoting component” refer to any material that, when included in the composition, enhances the adhesion of the coating composition to a metal substrate. Organosilanes, such epoxy-silanes or amino-silanes are commercially available adhesion promoters.

The coating composition may also include any suitable catalyst. Catalysts promote curing and examples of catalysts include tertiary amines, metal compound catalysts, imidazoles, or Lewis bases (e.g., tris-(dimethylaminomethyl) phenol), commercially available as ANCAMINE K54 from Air Products, but the present disclosure is not limited thereto. Examples of suitable tertiary amine catalysts include triethylamine, N-methylmorpholine, triethylenediamine, pyridine, picoline, and the like, but the present disclosure is not limited thereto. Examples of suitable metal compound catalysts include compounds of lead, zinc, cobalt, titanate, iron, copper, and tin, but the present disclosure is not limited thereto. For example, the metal compound catalyst may include lead 2-ethylhexoate, zinc 2-ethylhexoate, cobalt naphthenate, tetraisopropyl titanate, iron naphthenate, copper naphthenate, dibutyl tin diacetate, dibutyl tin dioctate, dibutyl tin dilaurate, and the like.

When used, the catalyst may be present in the epoxy coating composition in a total amount of 0.001 to 3 weight percent (e.g., 0.01 to 2.0 weight percent, or 0.001 to 0.05 weight percent) based on the total weight of the resin solids in the coating composition (e.g., based on the total weight of the solid film). For example, the catalyst may be present in the coating composition in an amount of 0.005 to 0.02, or 0.80 to 1.10, weight percent based on the total weight of the resin solids in the coating composition.

As noted above, the epoxy coating compositions used in the present invention are typically multi-component coating compositions, because of the epoxy and amine reaction. The epoxy and amine used in the present invention may be chosen so that the epoxy coating can cure under ambient conditions. By ambient conditions is meant that the coating undergoes a thermosetting reaction without the aid of heat or other energy, for example, without baking in an oven, use of forced air, or the like. While described herein as comprising a first and a second component, it will be understood that any number of additional components can also be used in the formulation of the coating. The components will be admixed prior to application. Typically, a multi-component system will include a base component, e.g., the epoxy functional resin, an activator or crosslinker component, e.g., the amine, and optionally a third component, e.g. a thinner component, e.g., water or an aqueous solution. Other ingredients can optionally be contained in any of the components. The components of the mixture may be combined shortly before application to the substrate. For example, the epoxy functional resin base component and the amine activator component, and any other additional components, if used, may be stored separately and mixed just prior to application.

The epoxy resin and amine together comprise a film-forming resin. As used herein, the term “film-forming resin” refers to resins that can form a self-supporting continuous film on at least a horizontal surface of a substrate upon removal of any diluents or carriers present in the composition or upon curing at ambient conditions or elevated temperature.

It is also possible to use one or more additional film-forming resins in the coating. Additional film-forming resins that may be used include, without limitation, those used in aerospace coating compositions, automotive OEM coating compositions, automotive refinish coating compositions, industrial coating compositions, architectural coating compositions, and coil coating compositions, among others. Additional film-forming resins suitable for use in the coating compositions of the present invention include, for example, resins based on acrylic, saturated or unsaturated polyester, alkyd, polyurethane or polyether, polyvinyl, cellulosic, silicon-based polymers, co-polymers thereof, which resins may contain reactive groups such as epoxy, carboxylic acid, hydroxyl, isocyanate, amide, carbamate, amine and carboxylate groups, among others, including mixtures thereof. Combinations of film-forming resins can be used. For example, the additional film-forming resin included in the epoxy coating compositions used in the present invention may comprise a resin with functionality that will cure with the amine, or alternatively, one or more additional crosslinkers can be used. Suitable crosslinkers can be determined by those skilled in the art based on the additional resin(s) chosen.

The epoxy coating compositions used herein may be in the form of liquid coating compositions, examples of which include waterborne (WB) and solvent-borne (SB) coating compositions and electrodepositable coating compositions. The coating compositions of the present invention may also be in the form of a co-reactable solid in particulate form (i.e., a powder coating composition).

When water is used as the primary diluent (i.e. greater than 50%), the coating composition may be a waterborne coating composition. In other embodiments, when solvent is used as the primary diluent (i.e. greater than 50%), the coating composition may be a solvent borne coating composition. For example, the present epoxy coatings may comprise solvents, such as ketone, acetate, glycol, alcohol and/or aromatic solvents. Exemplary suitable solvents are described in U.S. Pat. No. 6,774,168 at column 3, lines 28 to 41, the cited portion of which is incorporated by reference herein.

The epoxy coating composition described herein may be used to coat any suitable surface of any suitable substrate. For example, the epoxy coating composition may form a coating on a metal and/or a metal alloy (e.g., a metal substrate). Specific substrate examples include aluminum, aluminum alloys (e.g., zinc-aluminum alloys), titanium, titanium alloys, composite material (e.g., carbon-fiber reinforced polymer), steel (e.g., sheet steel, cold rolled steel, electrogalvanized steel, hot-dipped galvanized steel, aluminum plated steel, aluminum alloy plated steel, and/or stainless steel), cast iron, non-ferrous metals (e.g., brass, bronze, and/or magnesium, copper, silver, gold and/or alloys thereof), urethane, graphite, acrylics, and/or polycarbonates, but the substrate is not limited thereto. As used herein, the term “carbon-fiber reinforced polymer” refers to any suitable carbon-fiber reinforced plastic, carbon-fiber reinforced thermoplastic, or carbon fiber, and may include any suitable polymer (e.g., a thermoset or thermoplastic polymer or resin), such as epoxy, polyester, vinyl ester and/or nylon, and a reinforcing fiber, such as carbon fiber, aramid fiber, aluminum fiber and/or glass fiber.

The substrate coated according to the present invention may comprise part of a vehicle. “Vehicle” is used herein in its broadest sense and includes all types of vehicles, such as but not limited to airplanes, helicopters, cars, trucks, buses, vans, golf carts, motorcycles, bicycles, railroad cars, tanks and the like. It will be appreciated that the portion of the vehicle that is coated according to the present invention may vary depending on why the coating is being used.

At least a portion of the epoxy layer can directly contact an external environment. For example, the epoxy layer may be the outermost coating layer with no additional coatings applied to the exterior surface of the epoxy layer. As used herein, the statement “no additional coating” does not exclude the possibility of a temporary protective coating or layer being placed on the epoxy layer and then being later removed, or the possibility of a component of the environment adjacent to the coating forming a layer on the epoxy layer by chemical or physical reaction. For example, water vapor from the environment adjacent to the coating (or any other component of the environment, such as oxygen) may condense on the coating to form a water layer (e.g., a layer of chemisorbed or physisorbed oxygen, or a layer of ice), and at least a portion of the epoxy layer may still directly contact an external environment adjacent to the coating, the epoxy layer may still be a topcoat and the coating may still have no additional coatings on the epoxy layer, as described herein.

The epoxy layer may also be in direct contact with a topcoat (e.g., a transparent topcoat, such as a clearcoat). For example, a coating system comprising the epoxy layer and a topcoat directly on (e.g., physically contacting) at least a portion of the epoxy layer might be deposited on the substrates of the present invention. The topcoat may be the outermost coating layer. In some substrates according to the present invention, at least a portion of the epoxy layer may be in direct contact with an uncoated substrate and at least a portion of the topcoat may be directly on the epoxy layer, and at least another portion of the topcoat may be directly on the uncoated substrate.

The substrate of the present invention can be coated by applying the epoxy coating composition to at least a portion of a substrate, and at least partially curing the epoxy coating composition. The epoxy coating composition may be applied using any suitable method. For example, the epoxy coating composition may be applied using any suitable spraying, coating or other techniques generally used in the art of forming coatings. At least partially curing the coating composition may form an at least partially cured epoxy layer, and the method may further include forming a layer (e.g., a topcoat) directly on the at least partially cured epoxy layer. The epoxy layer may also be fully cured prior to application of a topcoat layer. The epoxy coating composition cures as epoxide groups of the non-aromatic epoxy resin react with amine functional groups. If the mixture comprises solvent, for example, at least a portion of the solvent may be “flashed off” before the additional layer (e.g., the topcoat) is applied to the epoxy layer. The epoxy layer may be cured for any suitable period of time; in some cases this may be a period of time lasting as long as one week. If an additional layer or coating is to be applied to the epoxy layer, after curing the epoxy layer, a surface of the epoxy layer may be abraded to improve adhesion of the additional layer (e.g., the topcoat) to the epoxy layer. Abrading the surface of the epoxy layer roughens the surface and improves adhesion of other layers (e.g., the topcoat) to the epoxy layer.

In multi-component coatings, the base component and activator component may be mixed at a ratio of reactive epoxy groups to reactive amine groups of 0.5:1.0 to 1.0:0.5. The base component and activator component may be mixed in equal volumes (e.g., at a 1:1 volume ratio, or a 100 to 91.2 weight ratio) or volumes in which either component is in excess, such as 10:1-1:10. When a solvent, such as acetone, is used, the base component, activator component and solvent may be mixed at a volume ratio of 1.0/1.0/0.5 (e.g., a weight ratio of 100/91/29.3), although other ratios are also within the scope of the invention. Upon being mixed and coated onto a substrate, the coating composition cures as the epoxide groups of the non-aromatic epoxy resin react with the curing agent (e.g., the amine curing agent). Either or both of the base component and the activator component may, optionally, include a solvent. Alternatively, the base component and activator component may be mixed to form a mixture, and a solvent may, optionally, be added to the mixture of the base component and the activator component (e.g., as a thinner). The solvent may be present in the mixture (e.g., the coating composition) in an amount of 10 to 75 vol %, based on the total volume of the mixture. When the solvent is used as a diluent (or thinner), the coating composition may be a solvent borne coating composition. For example, in some embodiments, the solvent may include ketone, acetate, glycol, alcohol and/or aromatic solvents. Examples of the solvent include those described in U.S. Pat. No. 6,774,168 at column 3, lines 28 to 41, the cited portion of which is incorporated by reference herein.

As noted above, the epoxy layer may have deposited on at least a portion any suitable topcoat, for example, as a protective layer. For example, the coating may include a durable, chemically resistant aerospace topcoat, but the topcoat is not limited thereto. The topcoat may include a clearcoat. The topcoat may be solventborne, waterborne, or a powder coating. For example, the topcoat may include a polyurethane polymer, a reaction product of reactants including a polyol and an aminoplast, a reaction product of reactants including a carbamate and an aminoplast, a reaction product of reactants including an epoxy resin and a polycarboxylic acid, a reaction product of a polyol and a blocked isocyanate, an alkyd, an acrylate polymer, a polymer including an acrylate and a reaction product of reactants including a polyol and an isocyanate, and mixtures thereof, but the topcoat is not limited thereto.

For example, the topcoat may be formed from the reaction of hydroxyl functional polyols and organic polyisocyanates to form a polyurethane polymer. In some embodiments, the topcoat includes a polyurethane polymer cured under ambient conditions. Suitable polyurethane coatings include two-part coating compositions, but the topcoat is not limited thereto. The two-part topcoat composition may include a base component and an activator component. The activator component may include compounds having isocyanate functionality, and the base component may include compounds having hydroxyl functionality. The base and activator components may be mixed just prior to the application of the coating composition to form the topcoat. Upon being mixed and coated onto a substrate, the coating composition cures as the isocyanate groups in the activator component react with the hydroxyl groups in the base component, yielding the polyurethane coating.

As noted above, it is optional to include a layer on top of the epoxy layer according to the present invention. Accordingly, the present invention includes application of an epoxy coating to an uncoated substrate and use without any additional coating, such as a topcoat, being deposited on the epoxy layer. When used without such a topcoat, the epoxy layer has significantly improved UV resistance (when tested for UV exposure according to ASTM D523-14) as compared to similar coating compositions that contain high(er) levels of aromatic epoxy. As a result, the present coatings may have a higher retained gloss and lower CIE delta E color change when compared to a coating containing high(er) levels of aromatic epoxy.

The epoxy layer of the present invention may have a dry film thickness of 0.1 to 10 mils, such as 0.1 to 5 or 0.5 to 2.5. The epoxy layer can have a dry film thickness of greater than 2 microns. If a topcoat is applied thereto, it may have a dry film thickness of 0.1 to 10 mils, such as 0.1 to 5 or 0.5 to 2.5.

As used herein, unless otherwise expressly specified, all numbers such as those expressing values, ranges, amounts or percentages may be read as if prefaced by the word “about”, even if the term does not expressly appear. Plural encompasses singular and vice versa. For example, while the invention has been described in terms of “a” corrosion inhibitor, “a” non-aromatic epoxy resin, “an” amine, and the like, mixtures of these and other components, can be used. Also, as used herein, the term “polymer” is meant to refer to prepolymers, oligomers and both homopolymers and copolymers; the prefix “poly” refers to two or more. When ranges are given, any endpoints of those ranges and/or numbers within those ranges can be combined with the scope of the present invention. “Including”, “such as”, “for example” and like terms means “including/such as/for example but not limited to”. The terms “acrylic” and “acrylate” are used interchangeably (unless to do so would alter the intended meaning) and include acrylic acids, anhydrides, and derivatives thereof, lower alkyl-substituted acrylic acids, e.g., C₁-C₂ substituted acrylic acids, such as methacrylic acid, ethacrylic acid, etc., and their C₁-C₆ alkyl esters and hydroxyalkyl esters, unless clearly indicated otherwise.

The following example is presented for illustrative purposes only and does not limit the scope of the present invention.

### Example 1

An aircraft grade aluminum alloy 2024 substrate was prepared by mildly abrading with Scotch Brite 7447 pads and deoxidizing the substrate with EAC8 (available from PPG Aerospace). The substrate was rinsed to a clean water break, dried for 30 minutes or more, and then treated with DESOGEL EAP-9 (as a sol-gel composition; available from PPG Aerospace) according to manufacturer's instructions to form a conversion coating.

A base component was prepared by mixing 32.2 parts by weight of ANCAMIDE 2445 (an amine functional polyamide curing agent), 6.9 parts by weight of ANCAMINE 1895 (a polyamine curing agent), 1.4 parts by weight of ANCAMINE K-54 (an amino phenol catalyst)—ANCAMIDE 2445, ANCAMINE 1895 and ANCAMINE K-54 are available from Air Products, Allentown, Pa., 18.9 parts by weight of n-butyl alcohol (as a solvent), 4.6 parts by weight of xylene (as a solvent), 34.6 parts by weight of magnesium nano-particles (as a corrosion inhibitor, commercially available from Nano-Structured and Amorphous Materials), 10.3 parts by weight of Sachtleben Micro (a barium sulfate filler; available from Sachtleben Chemie GmbH, Duisburg, Germany), 3.8 parts by weight of GASIL IJ35 (a particulate silica; available from PQ Corporation, South Gate, Calif.), and 0.1 parts by weight of RAVEN 14 carbon black (as a colorant; available from Birla Carbon), based on 112.7 total parts by weight. An activator component was prepared by mixing 47.6 parts by weight of EPONEX 1510 (as a non-aromatic epoxy resin; available from Momentive, Columbus, Ohio), 23.8 parts by weight of methyl amyl ketone (as a solvent), 23.8 parts by weight of TI-PURE R-706-11 titanium dioxide (as a pigment; available from DuPont), 2.0 parts by weight of iron oxide yellow (as a pigment), 4.0 parts by weight of SILQUEST A-187 (an epoxy silane adhesion promoter; available from Momentive, Columbus, Ohio), and 1.6 parts by weight of BYK-358N (as a rheology modifier; available from Altana AG, Wesel, Germany), based on 102.8 total parts by weight.

112.8 parts by weight of the base component, 102.8 parts by weight of the activator component and 33 parts by weight of acetone (as solvent), based on 248.5 total parts by weight, were mixed to prepare a coating composition. The coating composition was sprayed onto the conversion coating of the substrate and cured to form an epoxy layer according to the present invention. Cure was effected under ambient conditions for 14 days. A clearcoat composition (CA 9005 from PPG Aerospace) was sprayed onto the epoxy layer and cured by ambient cure. The dry film thickness of the epoxy layer was 1.5 to 2.0 mils and of the clearcoat layer was the same.

Directly after mixing, the viscosity of the epoxy coating composition of Example 1 was measured according to ASTM D4212-10. The coating composition of Example 1 exhibited a viscosity (in seconds) of 17.2. After 3 hours of pot life, the viscosity of the epoxy coating composition of Example 1 was tested again according to ASTM D4212-10. After 3 hours of pot life, the epoxy coating composition of Example 1 exhibited a viscosity (in seconds) of 17.4.

The 20° and 60° gloss measurements of the coating system (epoxy coating plus clearcoat) of Example 1 were measured according to ASTM D523-14. The coating system of Example 1 exhibited a 20° gloss measurement of 77.9 and a 60° gloss measurement of 85.6.

The coated substrate was then subjected to 2500 hours of UV exposure according to ASTM G 154. The 20° and 60° gloss measurements of the coating system of Example 1 were then measured after the 2500 hours of UV exposure according to ASTM D523-14. After the 2500 hours of UV exposure, the coating system of Example 1 exhibited a 20° gloss measurement of 71.2 and a 60° gloss measurement of 81.3. It will be appreciated by one skilled in the art, that this change in gloss is very small and therefore indicative of a coating system having good exterior durability.

The CIE of the coating system of Example 1 was also measured both before and after the 2500 hours of UV exposure. After the 2500 hours of UV exposure, the coating system of Example 1 exhibited a CIE ΔE of 1.24. It will be appreciated by one skilled in the art, that this change in CIE is very small and therefore indicative of a coating system having good resistance to UV degradation.

The substrate coated as described above also has corrosion resistance properties.

Whereas particular embodiments of the present disclosure have been described above for purposes of illustration, it will be understood by those skilled in the art that numerous variations of the details of the present disclosure may be made without departing from the invention as defined in the appended claims, and equivalents thereof.

Although various embodiments of the present disclosure have been described in terms of “comprising” or “including,” embodiments consisting essentially of or consisting of are also within the scope of the present disclosure. For example, while the present disclosure describes an epoxy layer and, in some cases, a topcoat deposited thereon, a coating system consisting essentially of, or consisting of, the epoxy layer or the epoxy layer and the topcoat is also within the scope of the present disclosure. In this context, “consisting essentially of” means that any additional components in the primer-less coating system will not materially affect the adhesion of the epoxy layer to a substrate or the performance of the epoxy layer.

What is claimed is:

1. A substrate at least partially coated with an epoxy coating composition comprising a corrosion inhibitor, a non-aromatic epoxy resin, and an amine, wherein the substrate is not coated with an organic coating prior to application of the epoxy coating composition.

2. The substrate of claim 1, wherein the non-aromatic epoxy resin comprises an aliphatic epoxy resin.

3. The substrate of claim 1, wherein the epoxy coating composition comprises 5 wt % or less of an aromatic epoxy.

4. The substrate of claim 1, wherein the epoxy coating composition comprises 2 wt % or less of aromatic epoxy.

5. The substrate of claim 1, wherein the amine comprises a blend of a polyamide and a polyamine.

6. The substrate of claim 1, further comprising a clearcoat deposited on at least a portion of the epoxy coating.

7. The substrate of claim 1, wherein the substrate comprises aluminum and/or an aluminum alloy.

8. The substrate of claim 1, wherein the substrate forms part of a vehicle.

9. The substrate of claim 8, wherein the vehicle is an airplane.

10. A method of preparing the substrate of claim 1, comprising:
applying the epoxy coating composition directly to at least a portion of the substrate; and at least partially curing the coating composition.

11. The method of claim 10, further comprising pretreating and/or conversion coating at least a portion of the substrate before applying the epoxy coating composition.

12. The method of claim 10, further comprising applying a clearcoat on at least a portion of the at least partially cured epoxy coating composition.
